(19) United States
(12) Patent Application Publication
(10) Pub. No.: US 2022/0237062 A1
(43) Pub. Date: Jul. 28, 2022

(54) POINTER CONSTRAINT MODELING THROUGH A MULTIGRAPH

(71) Applicant: Correct Computation, Inc., College Park, MD (US)

(72) Inventors: Michael W. Hicks, Silver Spring, MD (US); John Holman Kastner, College Park, MD (US); Aaron Joseph Eline, Reisterstown, MD (US)

(21) Appl. No.: 17/159,045

(22) Filed: Jan. 26, 2021

(51) Int. Cl. G06F 11/07; G06F 8/41; G06F 16/901; G06F 8/73

(52) U.S. Cl. CPC G06F 11/079; G06F 8/73; G06F 16/9024; G06F 8/437

(57) ABSTRACT

A graph structure provides a representation of source code and includes a plurality of nodes to represent a plurality of pointers within the source code, a plurality of type edges connecting nodes in the plurality of nodes within the graph structure (to identify a flow of a program to be implemented using the source code), and a plurality of checked edges based on respective usage of pointers in the plurality of pointers. A system determines, from the graph structure, whether one or more of the plurality of pointers comprise wild pointers based on one or more of the plurality of checked edges, and further determines, from the graph structure, pointer types for at least a portion of the plurality of pointers based on one or more of the plurality of type edges.

### BACKGROUND

The present disclosure relates in general to the field of computer software development, and more specifically, to assessing spatial security of pointers within source code.

Software programs may be written in any one of a variety of programming languages, with programs consisting of software components written in source code according to one or more of these languages. Development environments exist for producing, managing and compiling these programs. For instance, an integrated development environment (IDE), may be used which includes a set of integrated programming tools such as code editors, compilers, linkers, and debuggers. The specific development of a software system to be secure may play an integral role in securing computing systems more generally, including the invaluable and vast data and code being hosted on these systems.

### BRIEF SUMMARY

According to one aspect of the present disclosure, source code is accessed and parsed by a computer-implemented tool to automatically detect a plurality of pointers in the source code. A pointer is an address in memory at which the program stores data of a certain type, and this data could contain other pointers, i.e., addresses, to other data. A usage type of each of the plurality of pointers is determined, and from it a graph structure is generated for the source code, with the graph structure including a plurality of nodes corresponding to the plurality of pointers. Generating the graph structure includes determining whether one or more of the plurality of pointers are wild pointers, which may be subject to insecure usage, determining from the usage types of the plurality of pointers, determining a plurality of type edges based on the determined corresponding types to couple nodes in the plurality of nodes, and determining from the usage types of the plurality of pointers a plurality of checked edges to couple a subset of the nodes in the plurality of nodes.

According to another aspect of the present disclosure, a graph structure (such as the above) may be accessed, which includes a plurality of nodes to represent a plurality of pointers within the source code, a plurality of type edges connecting nodes in the plurality of nodes within the graph structure to identify a flow of a program to be implemented using the source code, and a plurality of checked edges based on respective usage of pointers in the plurality of pointers. A computer-implemented tool may take the graph structure as an input and use the graph structure to determine whether one or more of the plurality of pointers comprise wild pointers, and determine pointer types for at least a portion of the plurality of pointers. In some instances, the source code may be automatically annotated or modified by the tool based on the determined wild pointers and/or pointer types.

### BRIEF DESCRIPTION OF THE DRAWINGS

FIG. 1 is a simplified schematic diagram of an example computing system including an example development system in accordance with at least one embodiment.

FIG. 2 is a simplified block diagram of an example computing system including a source code converter in accordance with at least one embodiment.

FIG. 3 is a simplified block diagram illustrating use of an example source code converter in accordance with at least one embodiment.

FIG. 4 shows the conversion of a piece of code using an example source code converter.

FIG. 5A shows the example process flow of an example source code converter to generate modified source code in accordance with at least one embodiment.

FIG. 5B shows a simplified block diagram illustrating components of an example source code converter including a constrain builder and a constraint solver in accordance with at least one embodiment.

FIGS. 6A-6D illustrate the example generation of portions of a multigraph structure from example source code in accordance with at least one embodiment.

FIG. 7 illustrate the example generation of a multigraph structure from example source code in accordance with at least one embodiment.

FIG. 8 illustrates a mapping of portions of the source code to portions of the multigraph structure.

FIG. 9 illustrates an example constraint solution determined from an example multigraph structure.

FIG. 10 illustrates a mapping of portions of the multigraph structure to segments of safe and wild code in accordance with at least one embodiment.

FIG. 11 illustrates a mapping of portions of the multigraph structure to segments solved to a particular pointer type (e.g., ARR) in accordance with at least one embodiment.

FIGS. 12A-12C illustrate another example of the generation of a multigraph structure and performing constraint solving using the multigraph in accordance with at least one embodiment.

FIG. 13 illustrates inference of checked code regions in accordance with at least one embodiment.

FIG. 14 illustrates another example of inference of checked code regions in accordance with at least one embodiment.

FIGS. 15A-15C are simplified flowcharts illustrating example techniques associated with assessing source code for spatial security in accordance with at least some embodiments.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium (e.g., a non-transitory storage medium) produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

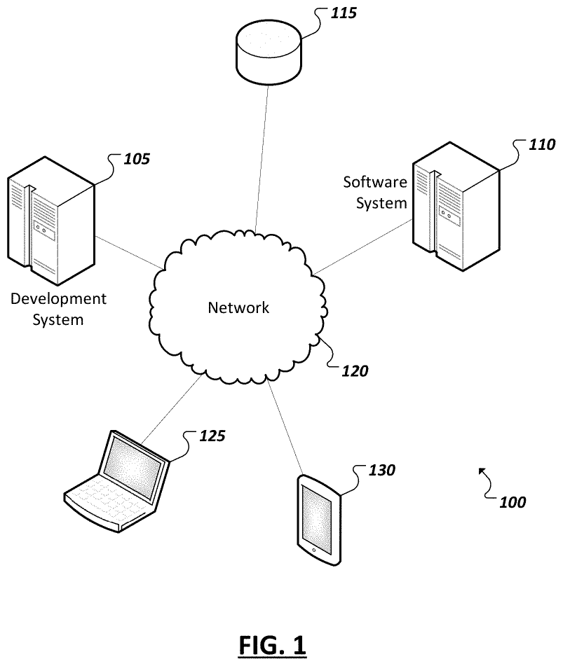

Referring now to FIG. 1, a simplified block diagram is shown illustrating an example computing environment 100 including an improved development system 105, which may host source code analysis, modeling, and/or conversion tools to improve the security of a piece of software code, such as found in a program. In some implementations, the improved software analysis and conversion tools may be included or offered together with a compiler or other software development tools, such as tools found within an integrated development environment. In some implementations, the improved tools may autonomously annotate and/or convert a code to a more secure, checked version of the code, including converting pointers within the code from an original unchecked, or legacy, version of the code to a checked, or safe and secure, version of the pointer, among other example functionality.

In some implementations, a development system 105 may be implemented as a hosted or local computing system, through which users (e.g., programmers, software testers, software engineers, etc.) may interact with the tools directly (e.g., through corresponding user interfaces (e.g., graphical user interfaces)). For instance, the development system 105 may be implemented as an IDE and/or compiler that is installed and run on a personal computer, among other examples. In other implementations, the development system 105 may be provided as a software as a service (Saar) or cloud-based service offering, hosted on one or more multiple network-connected computing systems, which other users (e.g., users of client systems 125, 130) may access the development system 105 over one or more networks (e.g., 120).

Other software systems and services (e.g., 110) may also communicate and interoperate with a development system 105 (e.g., a cloud-based implementation) over one or more local or wide-area networks (e.g., the Internet). For instance, a software system 110 may be utilized to host, test, secure, develop, or otherwise build or manage software code. Additionally, one or more repositories (e.g., 115) of software code may be provided and may be accessible over a network (e.g., by software system 110 or development system 105). For instance, tools and functionality provided by an improved development system (e.g., 105), such as discussed in more detail herein, may be utilized to automatically annotate or convert various pieces of software code developed, hosted, or managed by software system 110, repository system 115, or personal computing client system 125, 130, among other examples. For instance, a piece of code may be accessed by the development system 105 over network 120 and processed by the development system 105 to determine opportunities to convert pointers to checked versions of the pointers. The development system 105, in some implementations, may further generate a secured, or checked, version of the same piece of code and provide the improved version as an output (e.g., delivered over network 120) to a source of the code (e.g., other connected systems 110, 115, 125, 130), among other example implementations.

In general, “servers,” “clients,” “computing devices,” “network elements,” “database systems,” “user devices,” and “systems,” etc. (e.g., 105, 110, 115, 125, 130, etc.) in example computing environment 100, can include electronic computing devices operable to receive, transmit, process, store, or manage data and information associated with the computing environment 100. As used in this document, the term “data processing apparatus,” “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 125, 130, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a development system (e.g., 105), software system 110 (e.g., hosting one or more software applications), a repository systems (e.g., 115), or other system within computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Software system security continues to grow in importance. Many discovered and reported vulnerabilities, some of which are exploited by attackers and result in severe downstream effects, may be avoided through careful construction of the software. However, programmers seldom possess the level of expertise to appreciate the myriad ways in which design and coding choices may introduce vulnerabilities into the code, which may later serve as the gateway for an attack or exploitation of the resulting computing program. As an example, the C programming language provides a single type constructor to describe pointers to memory, but this constructor is tasked with characterizing four distinct patterns of use: (1) pointers to exactly one data item; (2) pointers to zero or more data items (an array); (3) pointers to an unknown number of non-NULL data items and concluding with a NULL; and (4) pointers to unstructured (“wild”) data. This ambiguity, and the programmer confusion that it causes, is the source of a large and pernicious class of security vulnerabilities based on illegal memory accesses. As such, it is desirable to make these distinct pointer usage patterns manifest in C programs, e.g., as distinct type constructors. Doing so is the basis of several efforts to build pre- and post-execution analyzers for C program source code, and/or to extend the C language itself with new types and annotations. Indeed, vulnerabilities that compromise memory safety are at the heart of many attacks. Memory safety has two aspects. Temporal safety is ensured when memory is never used after it is freed. Spatial safety is ensured when any pointer dereference is always within the memory allocated to that pointer. Buffer overruns—a spatial safety violation—still constitute a frequent and pernicious source of vulnerability, despite their long history.

Solutions have been attempted to address memory safety. Several efforts have been attempted to make C programs safe, in particular. Static analysis tools aim to find vulnerabilities by looking at a program's source code pre-deployment, but may miss bugs, have trouble scaling, or emit too many alarms. Security mitigations can mute the impact of vulnerabilities by making them harder to exploit, but provide no guarantees (e.g., data leaks and mimicry attacks may still be possible). Some efforts have aimed to provide spatial safety by adding code that performs run-time checks, during deployment, but such checks tend to add substantial overhead and can complicate interoperability with legacy code when pointer representations are changed. In sum, despite the multiple solutions that have been attempted, existing approaches remain deficient.

In one implementation, spatially safe programming languages have been developed, allowing incremental conversion while balancing control, interoperability, and high performance. In some implementations, a spatially safe programming language may represent all pointers in the code in their normal or legacy form (e.g., the form used in the standard, non-spatially safe version of the same programming language). The spatially safe programming language may explicitly specify the legal boundaries of pointed-to memory to enhance human readability and maintainability while supporting efficient compilation and running time. The spatially safe version of a programming language may support pointers of various types, and these types and bounds of the pointers may be used by the spatially safe compiler to either prove that an access is safe, or else to insert a run-time bounds check when such a proof is too difficult, among other example features. In some implementations, a spatially safe version of a programming language may be implemented as an extension of a compiler for a legacy or standard version of the programming language, among other examples. Indeed, in some implementations, such compilers or other tools may incorporate features and functionality to allow software code to be automatically converted, at least partially, into a spatially safe, or checked, version of the code, among other example features.

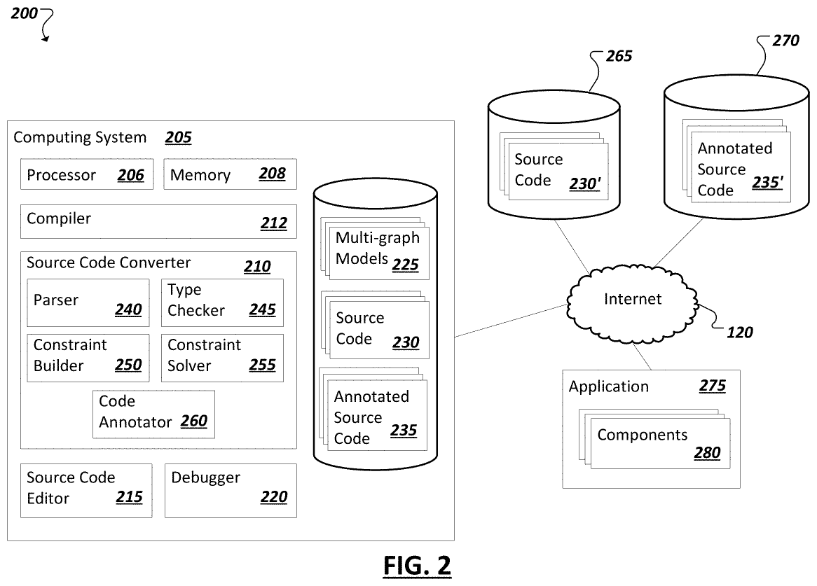

At least some of the systems described in the present disclosure, such as the systems of FIGS. 1 and 2, can include functionality to at least partially address at least some of the above-discussed issues, as well as others not explicitly described. For instance, in the example of FIG. 2, a simplified block diagram 200 is shown illustrating an example environment including an example computing system 205 hosting a compiler 212 and other software tools, such as a source code converter 210, source code editor 215, debugger 220, among other example tools. The computing system may include one or more data processing apparatus (e.g., 206) and one or more memory elements 208 for use in implementing executable modules, engines, or tools to implement functionality discussed herein, including compiler 212, source ode converter 210, among other example components. The IDE system 105 may additionally include one or more interfaces (e.g., application programming interfaces (APIs) or other interfaces), which may be used to communicate with and consume data and/or services of various outside systems, such as a repository system (e.g., 265, 270), software system (e.g., hosting application 275), among other examples.

In some implementations, a source code converter 210 may be provided, which may automatically inspect a piece of code (e.g., source code 230, 230′) to identify opportunities to improve the spatial safety of the code and automatically convert and/or annotate the code with new, improved code that resolves pointer-based vulnerabilities detected in the code (e.g., 230, 230′). In one example, the source code converter 210 may include a parser 240 to parse the code to identify pointers within the code and identify how the pointers are used within the code. Data may be generated by the parser to describe these pointers. A type checker 245 may be provided to identify, from the results of the parser 240, respective types of the identified pointers within the code. A constraint builder 250 may generate a multigraph model 225 for the code to identify whether the pointers are spatially safe. A constraint solver 255 may utilize the multigraph model 225 to determine, from the constraints, opportunities to annotate or convert the code to address spatial safety issues. A code annotator 260 may modify or annotate the code to implement or identify these opportunities (e.g., in annotated source code 235 generated by the source code converter), such as described in more detail herein. A user (e.g., human programmer) may utilize the annotated source code 235 to improve upon or attempt to “fix” the issues identified by the source code converter. Such annotated or converted versions of the source code may be provided (e.g., via network 120) to one or more remote repositories and the resulting code may be utilized to implement various components (e.g., 280) of a software application developed or improved utilizing source code converter 210, among other example uses.

As one example of a spatially safe programming language, a spatially safe version of C and C-based programming languages may be developed, such as Checked C. Checked C may support pointers to single objects, arrays, and NULL-terminated arrays. Checked C is designed to support incremental porting from legacy C. Programs may consist of a mix of checked and legacy pointers, and fully ported code can be annotated as within a checked region, which can be held blameless for any spatial safety violation. This guarantee is made possible by restricting any use of unchecked pointers and casts within the region. To allow existing unchecked code to be accessed by checked regions and with checked pointers, Checked C allows unchecked code to be annotated with bounds-safe interfaces. These describe the expected behavior and requirements of the code and can be added to parameters and return values of function declarations/definitions, function and record types, and global variables. Such interfaces support modular porting and use of legacy libraries. In a Checked C implementation, programmers can add safety with each use of a checked pointer, and then extend the safety guarantee by expanding the scope of checked regions. This may result in each step of the code enjoying a working software artifact. Ultimately, a fully-ported program is assuredly safe, and in the meantime scrutiny can be focused on any unchecked regions, making the process of a debugging significantly simpler and more directed. Indeed, a checked version of a programming language, such as a Checked C, may allow the base programming language (e.g., C) to be extended with bounds-enforced checked pointer types. These pointers may be backward binary-compatible with legacy C pointers and may co-exist with them, ensuring efficiency and allowing a program's continued use while it is retrofitted for security.

In some implementations, a source code converter or other tool (e.g., a compiler including the functionality of an example source code converter) may be provided to enable retrofitting of a program written in a particular programming language in accordance with a checked version of the programming language. For instance, a development environment, code checker, compiler, or other tool may be provided with source code conversion functionality implemented as a static analysis-based tool to ease the retrofitting process. In one example, a source code converter module or utility may include logic executable by a computing device to automatically convert legacy pointers to checked versions of the pointers (or “checked pointers”). Checked pointers may be represented as system-level memory words, with no “fattening” metadata attached. Regions of code using only checked pointers may enjoy local spatial safety, in that any run-time spatial safety violation cannot be blamed on code in a checked region. Checked pointers confer safety benefits. Files, functions, and even single blocks of code that use only checked pointers and avoid certain unsafe idioms (e.g., variadic function calls) can be designated as checked regions; such that the region is sure to be spatially safe in the sense that any run-time safety violation cannot be blamed on code in that checked region. Placing an entire program in a checked region ensures it is wholly spatially safe.

In some instances, the source code converter may be run iteratively or repeatedly on a piece of code to guide a human programmer in securing code against vulnerabilities related to pointers within the code. In some instances, completely porting an existing C program to Checked C by converting its pointers to a checked type may not be realistic. Accordingly, a source code converter may be utilized to automatically and effectively assist a human programmer in iteratively refactoring their program, interspersing uses of the tool with manual changes.

In one example implementation, the source code converter tool may be equipped with logic to determine which legacy pointers can be converted into checked pointers. In one example embodiment, pointers in the programming language may be one of multiple different types. For instance, in the example of C/Checked C, each pointer may be one of three possible types, _Ptr<T>, _Array_ptr<T>, or _Nt_array_ptr<T> (ptr, arr, and ntarr for short). These types represent a pointer to a single element (e.g., ptr), array of elements (e.g., arr), and null-terminated array (e.g., ntarr) of elements of type T, respectively. In this particular example, the array-based pointer examples arr and ntarr have associated bounds annotations. Here are the three different ways to specify the bounds for a pointer p; the corresponding memory region is at the right:

_Array_ptr<T> p: count(n) [p, p + sizeof(T ) × n)
_Array_ptr<T> p: byte_count(b) [p, p + b)
_Array_ptr<T> p: bounds(x, y) [x, y)

The interpretation of an ntarr's bounds is similar, but the range can extend further to the right, until a NULL terminator is reached (the NULL is not within the bounds). Roughly speaking, checked pointers have a subtyping relationship ntarr<arr<ptr, in that an ntarr can be used where an arr (of the same or lesser size) is expected, which can be used where a ptr is expected (as long as the array's size is at least 1). This ordering or hierarchy can be used because the side conditions about bounds tend to hold and can be fixed manually with ease by a human programmer in the event the code converter gets it wrong.

In the example illustrated in FIG. 2, a source code converter 210 may include a code parser 240 to automatically parse a piece of software code and identify pointers and other defined elements according to a programming language. The source code converter 210 may additionally include a type checker 245 to identify a type of each of the identified pointers within the piece of code. For instance, the source code converter 210 may implement a whole-program, constraint-based static analysis performing a task similar to a type qualifier inference. The source code converter 210 may determine whether a given pointer is checked (chk) or unchecked (wild) as a check-type qualifier k. Additionally, the pointer type (e.g., ptr, arr, or ntarr) may be determined as a qualifier on a checked pointer type, p. Unsafe casts (e.g., x=(int*)1) may constrain a pointer x to wild. Indexing or arithmetic pointer uses (e.g., a[i] or a++) may constrain pointer a to be arr or ntarr (e.g., since such operations disqualify its determination as ptr). Dataflow pointer uses (e.g., x=a) may result in a constraint being identified and defined between variables a and x, among other potential examples of qualifiers and constraints. Solving the constraints determines the (k, p) qualifiers for each pointer identified in the code. If the k qualifier k=chk, the pointer can be rewritten per p. If the k qualifier is k=wild, the pointer is to be labeled as wild, and so on, among other example implementations.

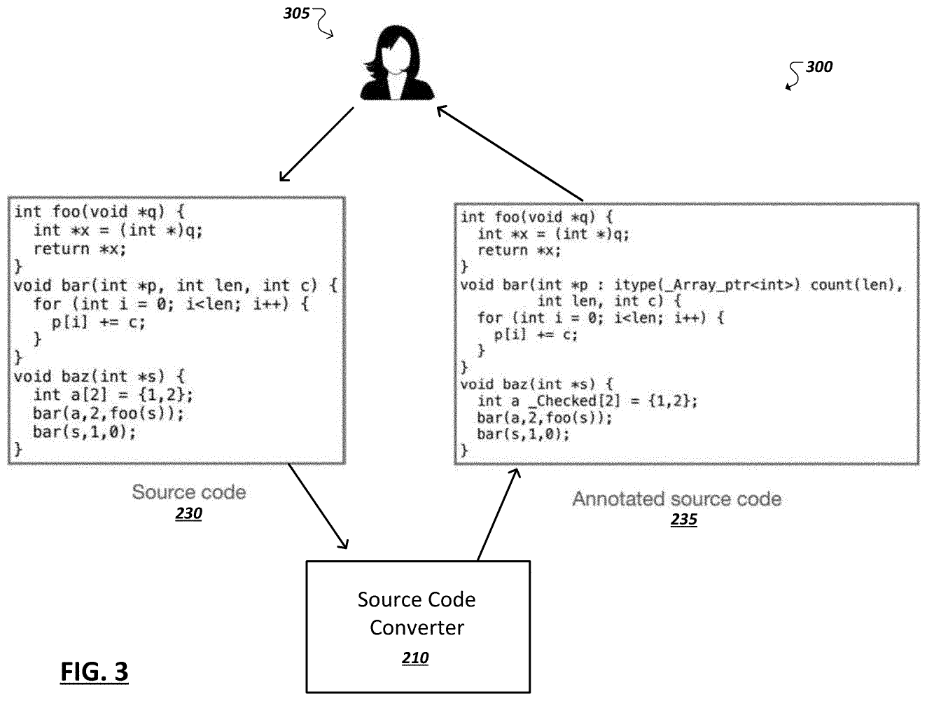

Turning to the simplified flow diagram 300 of FIG. 3, an example source code converter may be advantageously utilized in an iterative software development flow. For instance, a programmer (e.g., 305) may develop an example piece of source code (e.g., 230) representing at least a portion of a computer program. The piece of code 230 may be provided as an input to the source code converter 210 tool. The source code converter 210 may inspect the source code 230 and convert the code into an annotated version 235 of the code, which converts and/or identifies opportunities to convert various pointers within the code into checked versions of the pointers to enhance the safety of the code. The annotated source code 235 may be provided as an output of the source code converter, which the programmer 305 may utilize to determine root causes of unsafety within the code (e.g., from annotations generated and integrated within the annotated source code 235 by the source code converter 210). The programmer 305 may edit the code to generate an updated version of the source code, and this updated version of the source code may then be provided to the source code converter for further analysis and autonomous annotation or modification by the source code converter (e.g., to generate an annotated version of the updated source code for presentation to the programmer 305), and so on, until the code is made thoroughly and completely spatially safe.

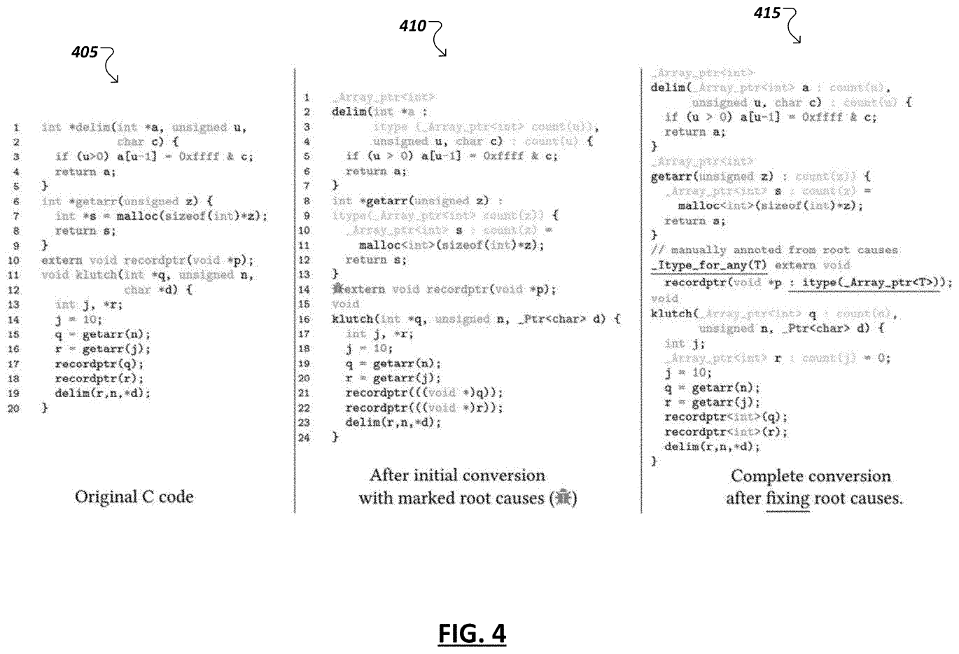

In one example, the source code converter 210 may infer checked pointer types, as a kind of type qualifier inference. FIG. 4 illustrates the example conversion of an original piece of code 405 using a source code converter 210 to convert the code into a checked region 415 of code. Using the source code converter iteratively, code 410 shows the code 405 after being run through the source code converter, allowing a human programmer to identify a root cause behind a source of insecurity within the code. The human programmer may attempt to rectify this cause and then rerun the source code converter (e.g., one or more additional times) to develop a fully-checked version of the code (e.g., 415).

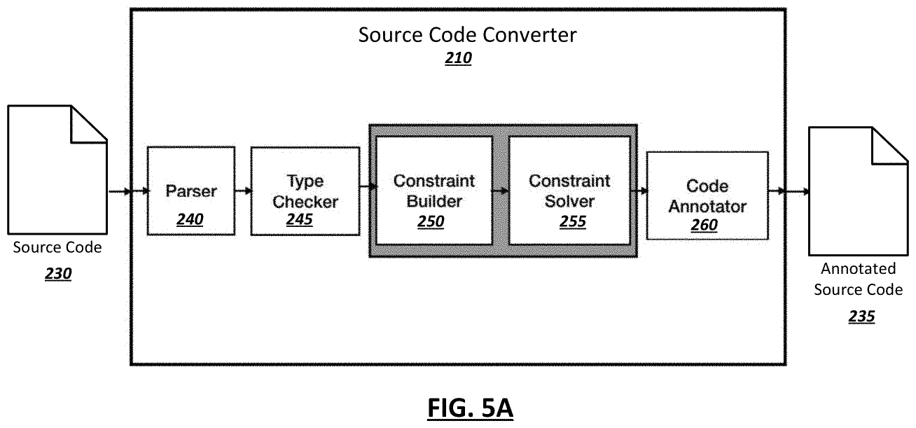

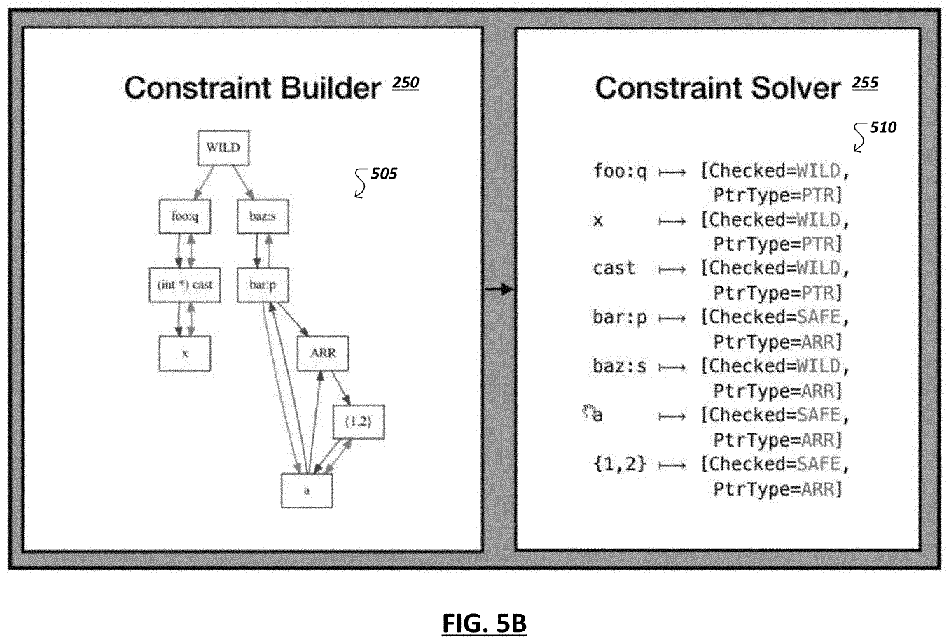

FIGS. 5A-5B illustrate an example flow of an example source code converter in generating an annotated version of source code 235 from a piece of source code 230 input to the source code converter 210. A parser 240 may first be utilized to parse the source code and determine its syntax (e.g., objects, function calls, pointers, etc.). A type checker 245 may determine the uses and types of each of the pointers detected within the code by the parser 240. The type checker 245 (and/or parser 240), in some implementations, may derive an abstract syntax tree (AST) describing the flow of the piece of source code 230, particularly the flow of pointer uses within the program. The abstract syntax tree may be further processed by the constraint builder to generate a graph data structure based on this determined flow. The graph data structure 505 (e.g., shown in FIG. 5B) generated by the constraint builder 250 may implement a graph-based representation that characterizes the code's 230 use of pointers so as to identify the various patterns of use of pointers within the program. For instance, in one implementation, the graph representation may identify the pointer uses from four use patterns: (1) pointers to exactly one data item; (2) pointers to zero or more data items (an array); (3) pointers to an unknown number of non-NUL data items and concluding with a NUL; and (4) pointers to wild data, based on the types of the pointers and their particular use/flow described in the abstract syntax tree (or other representation generated by the source code conversion tool.

Nodes in the graph generated by an example constraint builder represent respective pointers identified (e.g., by the parser) within the code 230. Edges of the graph represent relationships between pointers and constraints on their use. A pointer's pattern of use is determined by a choice (or “solution”) 510 that satisfies the constraints. The graph representation and solving algorithm can serve as the basis of a program analyzer that can find defects in the source code, due to inconsistent pointer use, and/or automatically modify or annotate the code to make manifest the program's use of these various patterns and whether the use represents potential vulnerabilities within the code. For instance, constraint solver 255 may take the data embodying the graph 505 to determine annotations and potential changes for pointers implemented within the code. The solution data generated by the constraint solver 255 may be passed to a code annotator block 555 to implement the annotations or changes to the code to generate the annotated version of the source code 235.

In some implementations, the graph (referred to herein also as a multigraph) generated by the constraint builder of an example source code converter may be a graph-based representation of constraints on pointer usage within the code. The graph structure is referred to as a multigraph, as it is generated to include two kinds of edges. One kind of edge constrains when a pointer must be wild, and the other kind characterizes the form of the pointed-to memory (e.g., single, array, NULL-terminated). The setup of wild/non-wild edges may be leveraged by the constraint solver to produces modular results, which are more understandable and maintainable for programmers. If an analyzed function internally uses only non-wild pointers, the constraint solved may identify this and present this result to the user/programmer (e.g., through the generated annotations) even if callers of the function elsewhere in the program pass it wild pointers. As such, programmers can trust that functions are safe if they have only non-wild pointers in their interface, so code reviewing effort can focus elsewhere.

As introduced above, constraint solving may utilize the multigraph as an input to determine a best solution of given pointers appearing within the code from the constraints for that pointer modeled within the multigraph structure. For instance, sometimes a pointer's memory may allow multiple characterizations. As an example, a pointer to an array of size 1 may also be a pointer to a single value. The question engaged by the constraint solver engine is to determine which characterization to use for each pointer detected within the code, so as to communicate most effectively to the programmer and to admit the greatest flexibility for future program maintenance. In one example, the possible use patterns (e.g., four use patterns) may be organized as a mathematical lattice. For instance, in one implementation, the use patterns may include NULL-terminated arrays (NT), arrays (ARR), single-term pointers (PTR), and wild or unstructured pointers (WILD) ordered as NT<ARR<PTR<WILD. The solving algorithm implemented by the constraint solved may include multiple phases, first choosing the least solution (in the lattice order) for function parameters which are pointers and then choosing the greatest solution for function returns that are pointers. Exceptions may be considered and implemented in the latter case based whether there are bounds owing to local usage; function-internal pointers also depend on certain bounds.

The multigraph structure generated by an example constraint builder engine provides a graph-based representation of pointers within the code. In some implementations, this graph may not only be a machine-consumable data structure (e.g., usable by constraint solver engines to automatically annotate or modify code, such as discussed herein), but may also be rendered as a graphical representation of code for presentation to a user/programmer (e.g., for reference during software development or troubleshooting). The multigraph may be presented graphically to allow this representation to be visualized alongside the code to assist in program understanding. It can be efficiently updated even as a program is being modified. For instance, edges characterize dependence, so only those parts of the graph that are affected by a change need to be changed. In this manner, the multigraph may be regenerated/updated in substantially real-time to reflect changes to the code made by the programmer, and these updates may be likewise presented to the user, among other example features.

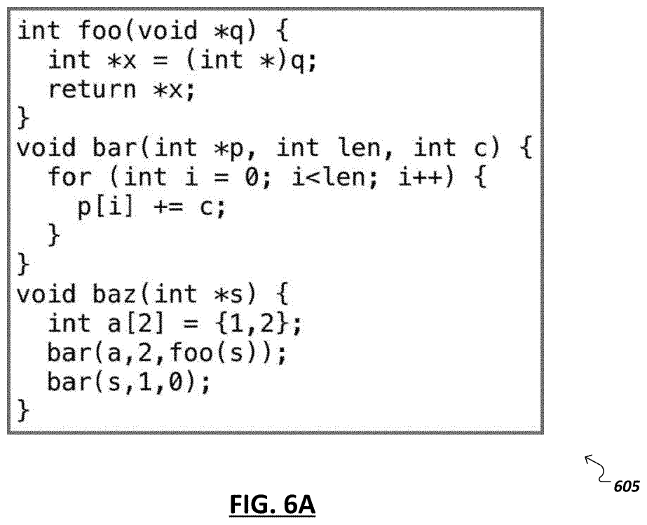

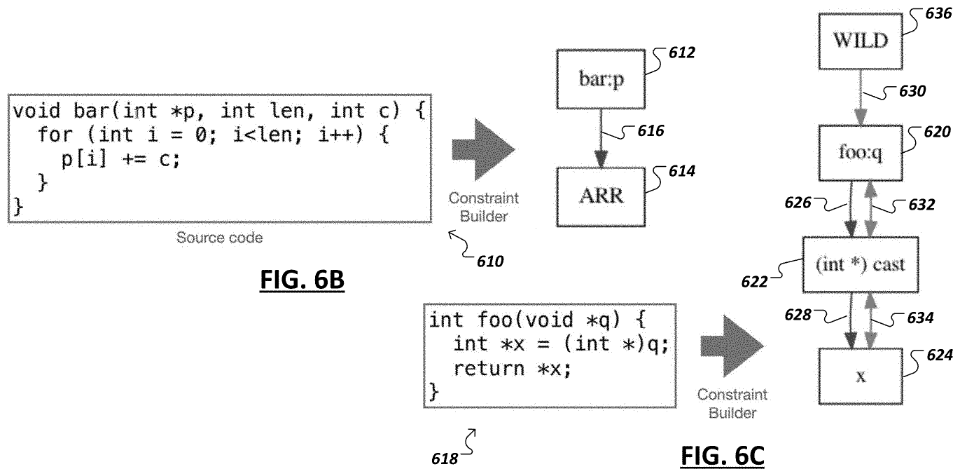

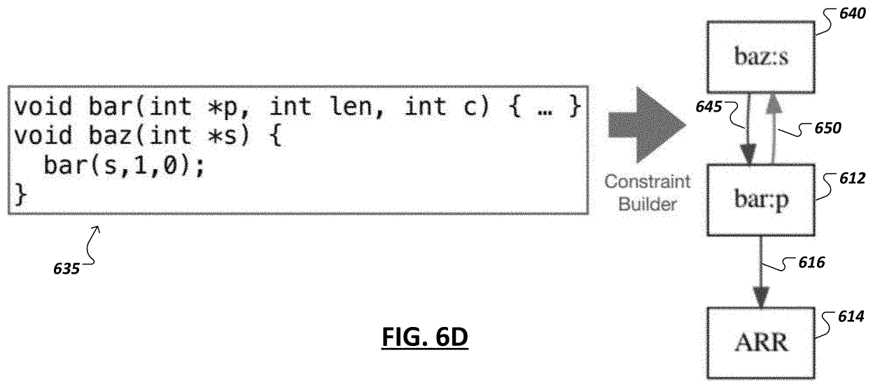

Turning to FIGS. 6A-6D, an example is illustrated of the modular construction of a simplified multigraph structure for a particular piece of code 605 (shown in FIG. 6A). A constraint builder engine (e.g., of an example source code converter) may identify various pointers within the code 605. For instance, turning to FIG. 6B, a pointer p in function bar (labeled bar:p) is identified and the corresponding code 610 is parsed to determine that bar:p is used as an array. Accordingly, a node 612 in the multigraph may be generated for the pointer and type edge 616 may be generated to show the type or pattern of use of the pointer as determined by the constraint builder (connecting node 612 to a type node 614 generated for array type pointers in the code). The constraint builder may further determine, for each pointer, whether the use of the pointer is safe and model this determination through “checked edges” provided in the graph. An example use of such edges is given next.

In FIG. 6C, an additional portion 618 of the source code 605 is identified as including pointers (e.g., foo:q, (int*) cast, and x). Corresponding nodes 620, 622, 624 may be generated for the multigraph structure and type edges 626, 628 may be determined based on the usage and interrelations between the pointers in the program. Additionally, checked edges 630, 632, 634 may be determined based on these usage types and based on whether usage of the pointer was safe or not. For instance, the constraint builder engine will detect that usage of the pointer foo:q is unsafe, wild, based on a type-incorrect cast; other examples of unsafe use include calls to external functions (which take unsafe pointers), or use by inline assembly code. In the case of a pointer being identified as wild, a WILD node 636 may be added to the multigraph, with checked edges (e.g., 630) being directed from the WILD type node 636 to the nodes representing pointers determined to be unsafe or unstructured (e.g., to node 620). Other checked edges may be generated based on the determined types of the pointers. For instance, for a pointer x assigned to another pointer y (e.g., x to (int*) cast), a bidirectional checked edge (e.g., 632, 634) may be added to reflect these relationships.

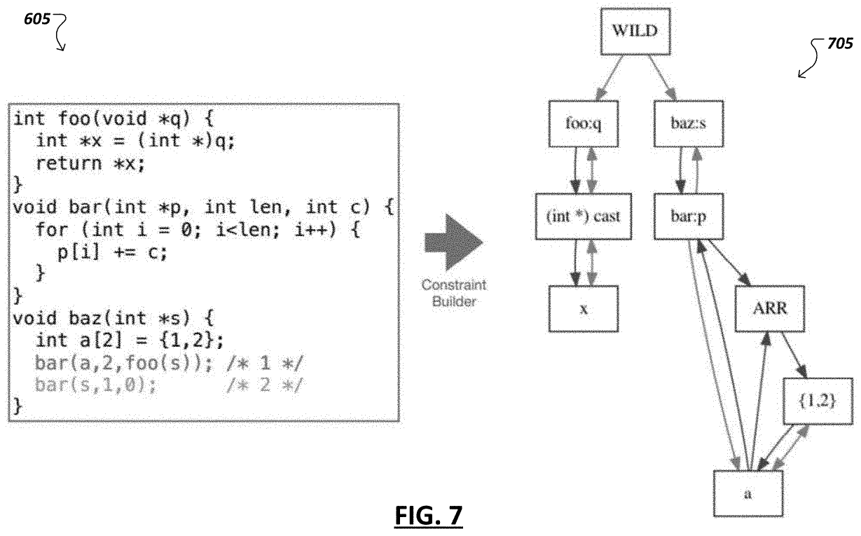

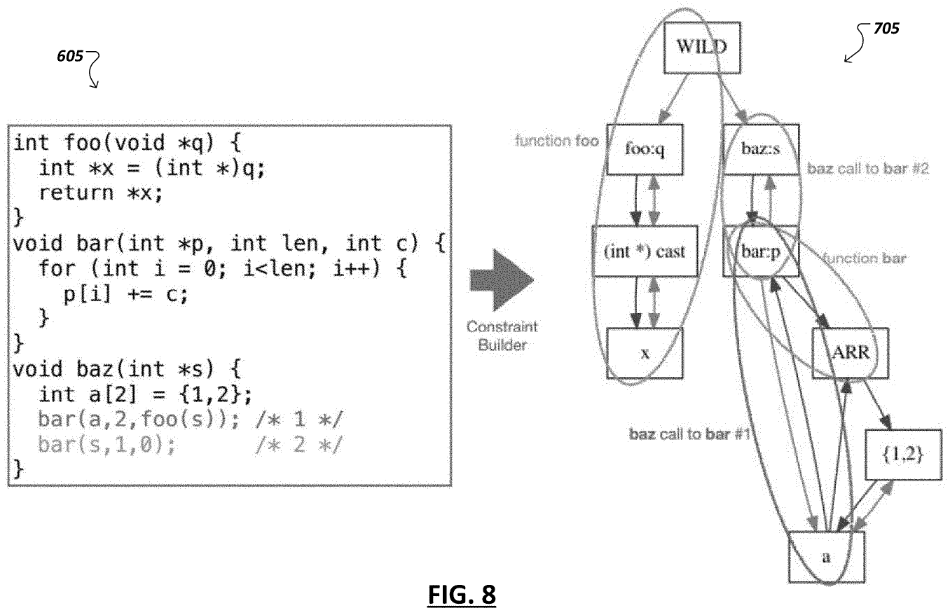

In FIG. 6D, an additional segment 635 of the code 605 is illustrated, for which additional portions of a corresponding multigraph may be built. For instance, when a pointer is passed to a function (e.g., as in baz:s (640) passed to function bar:p (612)), a type edge (e.g., 645) may be generated to show the relationship between the pointer and function, as well as a checked edge 650 in the reverse direction from the function node (e.g., 612) to the corresponding pointer node 640, among other examples. FIG. 7 illustrates the multigraph 705 built by the constraint builder engine from code 605, putting together into one graph all of the graphs produced as shown in FIGS. 6A-D. FIG. 8 shows this correspondence, mapping the functions and calls included within the code 605 to respective nodes and edges (or sections) of the multigraph 705.

In general, the constraint builder builds the multigraph 705 by generating a node in the graph for each pointer x in the program. For each pointer x: If the pointer x is used as an array (e.g., indexed as x[e] for some e), a type edge is added: x→ARR. If the pointer x is assigned to a pointer y, the constraint builder adds a type edge x→y and two checked edges x→y and y→x (or a bidirectional checked edge x↔y) to the multigraph. If the pointer x is used unsafely, the constraint builder adds a checked edge WILD→x to the multigraph. If the pointer x is returned from a function and assigned to pointer y, the constraint builder adds a type edge x→y and a checked edge y→x. The reversed direction of the checked edge for function calls is noteworthy as it may serve to model the localized unsafe usage of particular pointers within a piece of code, among other example advantages. Further, if the pointer x is assigned to by a call from a memory allocation (malloc), which creates multiple objects, the constraint builder adds a type edge ARR→x. If the pointer x is assigned to by a call from a memory allocation (malloc), which creates a single object, the constraint builder adds a type node pointer (PTR) and generates a corresponding type edge PTR→x. For each array x, if the array is a string, the constraint builder may add a type node for a NUL-terminated array NTARR to the multigraph and generate a type edge NTARR→x for that string (rather than a type edge ARR→x). For each function pointer ƒ, if the function has pointer arguments then a call to ƒ is handled as described above, where edges are produced between the arguments to the call and the parameters of the called function pointer. If the function pointer is passed to another function, its own parameters/returns match up with those of the called function's parameter. If the function ƒ has parameter x and the function being called has a function pointer parameter whose own parameter is y then the constraint builder reverses the flows of a normal call, by adding a type edge y→x and a checked edge x→y. If a function pointer is assigned to/from another function pointer/function, the constraint builder also reverses the typed-edge flow, but checked edges are bidirectional. For each integer z, a type edge PTR→&z may be added by the constraint builder if the expression &z appears in the program. Through this combination of assessments, the constraint builder may build corresponding sections of the multigraph for each pointer detected within the code to generate a complete multigraph (e.g., 705) with corresponding type and checked edges.

As introduced above, a constraint solver engine may take, as an input, a multigraph data structure generated by a constraint builder engine to determine constraints of the individual pointers. Specifically, the constraint solver engine may use the multigraph to map each node in the graph to WILD or SAFE and, for the pointers determined to be SAFE, map each node to a respective checked pointer type (e.g., PTR, ARR, NTARR, etc.). In one example, the constraint solver may begin by utilizing the multigraph to determine whether each pointer is WILD or SAFE. For instance, the constraint solver may traverse the graph from the WILD type node (e.g., 636) along (and in the direction of) the checked edges constructed within the multigraph to determine which nodes should also be regarded as wild. If a node cannot be reached by traversing the checked edges, it (and its corresponding pointer) may be considered safe by the constraint solver. For the nodes determined to be safe, the constraint solver may then determine the pointer type of each of the pointers (or at least each of the safe pointers) based on the respective type edges of the corresponding nodes.

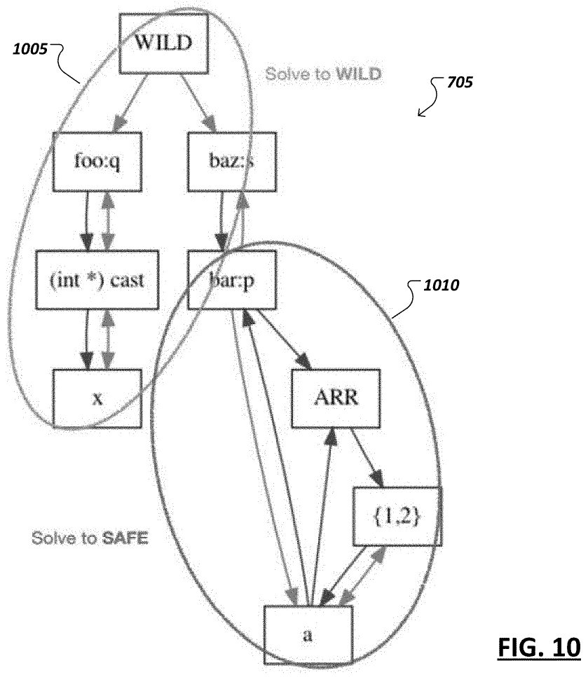

Continuing with the examples of FIGS. 6A-8, FIG. 9 illustrates an example solution 905 determined by a constraint solver engine from an example multigraph 705 generated by a constraint builder engine of a source code converter or compiler. As the WILD type node 636 is able to be traversed along checked edges 630, 632, 634, 915 to foo:q (620), baz:s (640), cast (622), and x (624), these are determined to be wild by the constraint solver. The “wildness” of baz:s, however, is constrained by virtue of the checked edge 650 pointing from bar:p (612) to baz:s (640), meaning that traversal of the graph along this branch 910 from WILD 636 is halted at this checked edge 650. Accordingly, in this example, constraint solver engine determines that bar:p, a and {1,2) are safe. FIG. 10 shows a summary of the portions 1005, 1010 determined by the constraint solver to be wild (1005) or safe (1010) based on processing of the multigraph 705 by the constraint solver engine. Further, based on the type pointers (e.g., type pointers traversing to ARR type node 614), pointer types (PtrType) may be determined for each of the pointers (as illustrated at 905).

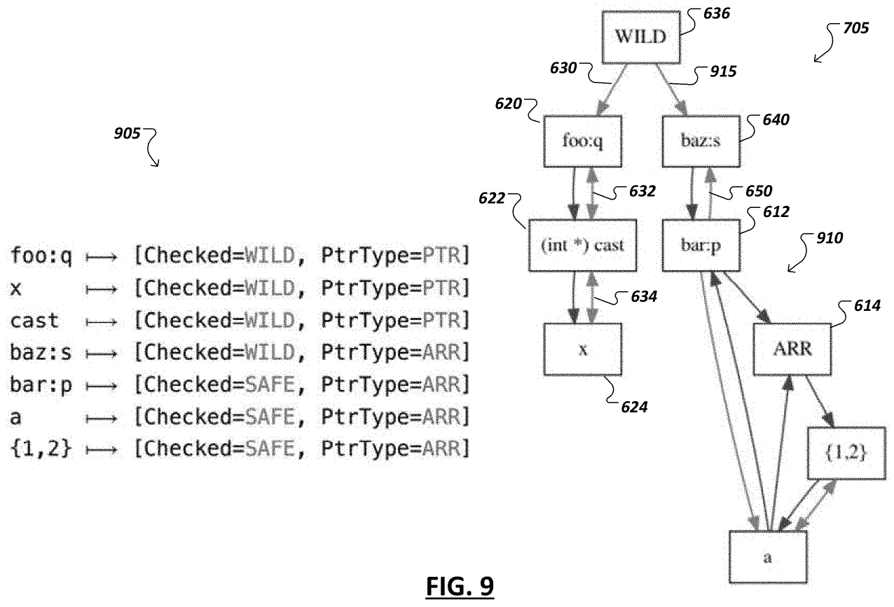

Continuing with the examples of FIGS. 9-10, as foo:q, x, and baz:s solve to WILD, direct edges from WILD are root causes (e.g., WILD→foo:q (from cast to (int*) in foo) and WILD→baz:s (from cast to void*by passing to foo)). By identifying the root causes of wildness within a piece of code, a programmer may attempt to fix these segments of code and resolve “downstream” wildness in other variable made WILD indirectly from relationships to these root causes (e.g., x is made WILD because foo:q is assigned to it; fixing the wildness of foo:q automatically fixes the wildness of x). Results generated by the constraint solver can further identify the root causes of wildness to a programmer as well as identify which root causes result in more indirect wild nodes. Accordingly, fixing root causes that result in more downstream wildness (or more indirectly wild variables) may be prioritized over other root causes determined by the constraint solver, among other example features. As an illustrative example, a program consisting of multiple source files may be provided as an input to a source code converter including a constraint builder engine and constraint solver engine, such as described herein. Suppose the constraint builder automatically detects and identifies 187 nodes made wild due to root cause edges, with another 293 nodes made wild indirectly. Accordingly, fixes made to the wild nodes may result in nearly a 2-for-1 impact in the code, among other examples.

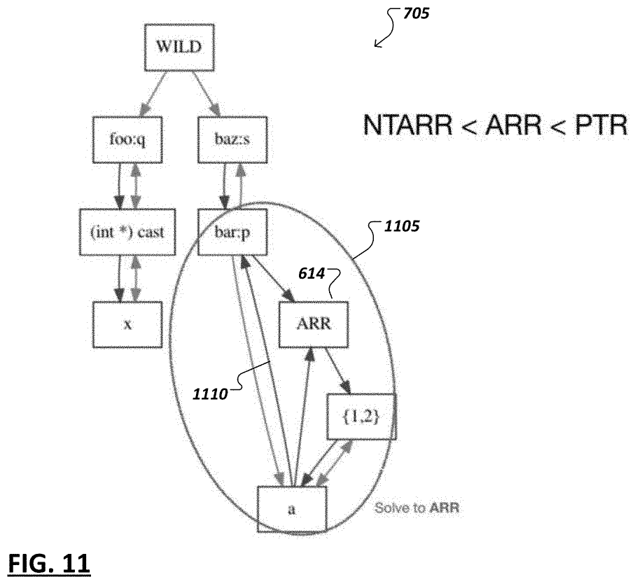

After determining whether each identified pointer in a piece of code is (potentially) wild or safe, the constraint solver may then determine, using the type edges in the multigraph, respective pointer types to be assigned to each of the pointers. The pointer type solutions may be based on an ordering of preference of supported pointer types from most to least specific. For instance, in an implementation supporting pointer types NTARR, ARR, and PTR, the ordering may be: NTARR<ARR<PTR. The type edges within the multigraph may be interpreted by the constraint solver to indicate that for a type edge x→y, it is interpreted that x y per the ordering of the pointer type ordering defined for the language. The solutions developed by the constraint solver are to respect these constraints in that constraints in the sense that substituting a solution for its variable satisfies the constraints. To illustrate, in the example of FIG. 11, a type edge 1110 exists from a→bar:p, meaning that the constraint solver pointer type solution is to obey the constraint sol(a) sol(bar:p). As both a and bar:p have type edges connecting directly to type node ARR, the preference is for ARR to be assigned as the pointer type of each pointer, so long as the constraint sol(a) sol(bar:p) is honored (as it is in this example). Extending this example, the type edges for branch 1105 of the multigraph 705 may be parsed by the constraint solver to determine the pointer type constraints: sol(bar:p) ARR sol({1,2}) sol(a) sol(bar:p). The only possible solution that satisfies these constraint is for sol(bar:p)=sol({1,2})=sol(a)=ARR, leading the constraint solver to the corresponding solution for these pointers and recommending substituting (or directly substituting) a checked ARR pointer type for these pointers. On the other hand, foo:q has no type edges pointing at it, so it is effectively unconstrained—any of PTR, ARR, or NTARR could be assigned to it. However, the source code converter may determine that the PTR solution is preferred because it is the highest in the ordering (e.g., the “greatest” solution), and thus the least specific. And, having chosen this solution for foo:q, the source code converter may determine that solutions for x and cast are to be PTR as well, due to the type edges between them.

In determining pointer type solutions for pointers using an example constraint solver (e.g., as in the example of FIG. 11), the constraint solver may generally first determine a greatest solution for parameters to functions, based on the pointer type ordering defined for the language (e.g., Checked C) and type edges within the multigraph. The constraint solver may then determine the least solution for returns from functions, based on whether any of the associated pointers has a specific bound defined in the multigraph by a type edge directly connecting the pointer to one of the pointer type nodes (e.g., ARR 614). If no node has a solution specified in the graph (e.g., a type edge to an ARR, NTARR, or PTR type node in the multigraph), the constraint solver may simply choose the greatest pointer type solution. Further, for local variables, the constraint solver may select the greatest solution.

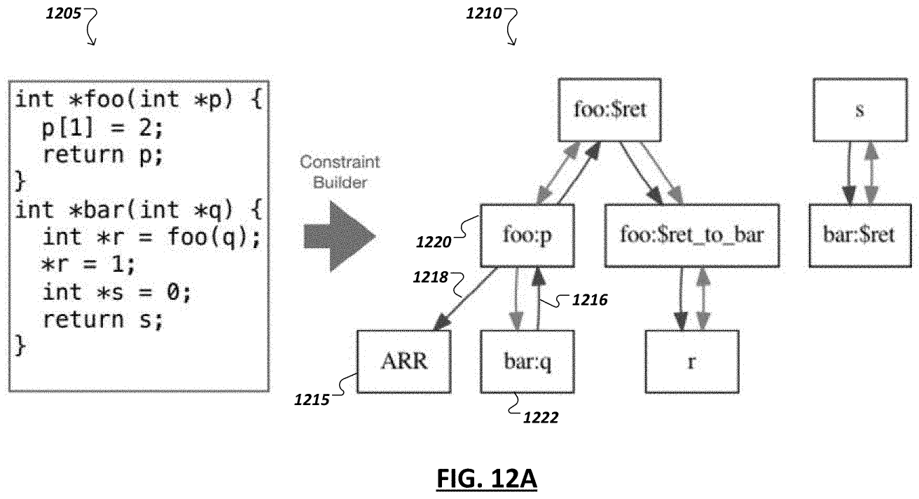

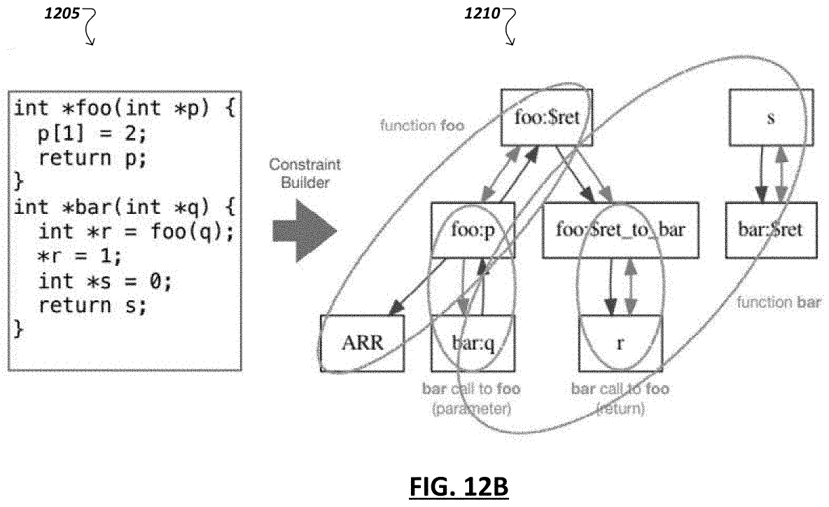

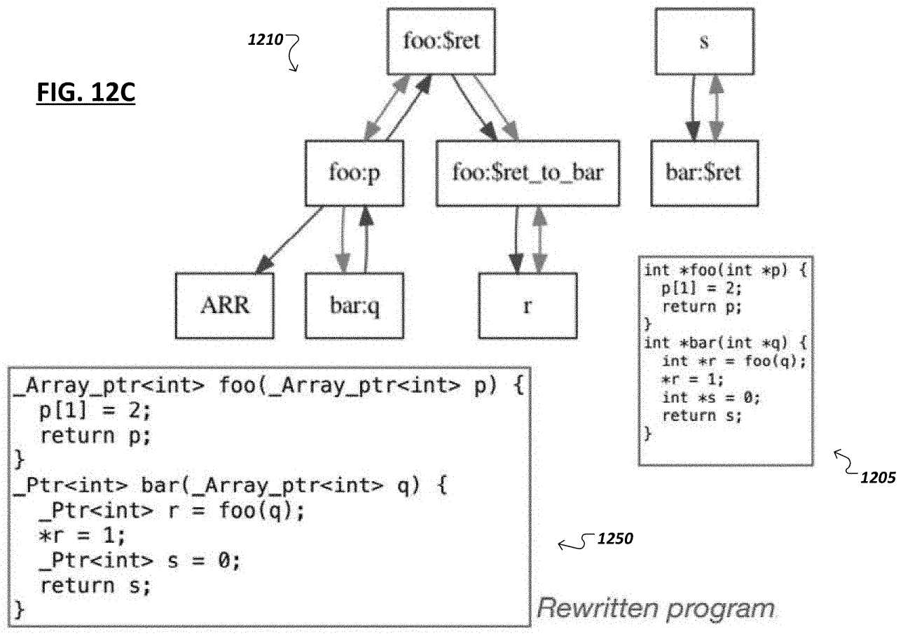

In one example, to compute the greatest solution for variables used as parameters to functions within the code, the constraint solver may initialize all solutions to the greatest pointer type in the ordering (e.g., PTR). The constraint solver may then identify any type nodes in the multigraph. FIGS. 12A-12C illustrate another example of the generation of a multigraph 1205 by a constraint builder engine fora particular piece of code 1210. FIG. 12A shows the example multigraph 1205 generated from piece of code 1210. FIG. 12B shows a mapping of the functions in the piece of code 1210 to sections of the multigraph 1210. In this example, no pointers have been determined to be wild (due to the absence of a WILD node within the multigraph 1205) and the only type node is ARR 1215. For the computation of the greatest solutions for parameters to functions, the constraint solver may determine the solution of parameters to functions by determining whether type edges within the graph (e.g., 1216, 1218) are traversable to couple a parameter node (e.g., 1220, 1222) to the type node (e.g., 1215). If so, the connected parameter node's solution may be updated to account for the type of the type node and the solving may continue for each of the parameter nodes by traversing the type edges in the multigraph to determine whether they connect the parameter node to another parameter node with an updated pointer type solution or one of the type nodes. If the parameter node does not couple to another parameter or a type node, the solution for that parameter node may remain set (to the greatest solution). To the extent that nodes are updated to different pointer type values, the ordering constraints governing in resolving which pointer type should be assigned—when computing the greatest solution, the highest-ordered eligible type would be chosen; for the least solution, the lowest-ordered would be. If no solution can be calculated that fulfills the constraints, the pointer(s) for which a solution cannot be determined may be determined to be WILD. A traversal (this time according to type edges, rather than the checked edges) may then be performed to determine whether any other pointers are affected by this wildness, and if so should be updated to WILD as well. The following pseudocode summarizes an example implementation of this solution:

```
initialize sol(x) of each variable x in the graph to PTR (the top of the lattice)
initialize worklist W to include constant types nodes (e.g., one or all of PTR, ARR,
NTARR)
while nonempty(W) do
  let x = take(W)
  foreach ptr-type edge y −> x
    set sol(y) = sol(y) [symbol]   sol(x) // greatest lower bound
      if sol(y) changed, insert(y,W)
foreach constant type node c && each ptr-type edge c −> x
  if c > sol(x) set fail(x) = true
foreach x such that fail(x) is true
  set checkedsol(x) = WILD and likewise all x −> ... −> y via ptr-type edges
```

In the particular example of FIG. 12A, constraint solving may begin by performing a greatest solution step for parameters to functions, by initializing solutions for each of the pointers and variables to PTR. A worklist may be initialized to include the (only) constant type node ARR 1215, since it is the only type node in the multigraph 1205. Solving may proceed as follows:

```
enter while loop
  let x = take(W), so x is ARR
    for edge foo:p −> ARR
      set sol(foo:p) = PTR [symbol]   ARR = ARR
      insert(foo:p,W)
  let x = take(W), so x is foo:p
    for edge bar:q −> foo:p
      set sol(bar:q) = PTR [symbol]   ARR = ARR
      insert(bar:q,W)
  let x = take(W), so x is bar:q //but no ptr-type edges from non-constant nodes
check constant-node edges //no edges from non-constant nodes
```

This yields solutions:

sol(foo:p, bar:q) = ARR
sol(foo:$ret, foo:$ret_to_bar, r, s, bar:$ret) = PTR

The constraint solver may then use these solutions and continue to the second step in the algorithm to determine least solutions for returns for functions in the code. Finding the least solution may be carried out similar to finding the greatest solution, except that initial unsolved variables are initialized to the lowest solution in the lattice, edges are considered from the taken node and not to it, and constraints are based on a least upper bound instead of a greatest lower bound. As with the greatest solutions, if a solution is not possible for a given pointer, then the pointer may be assigned a WILD status, and wildness may traverse from this node to other nodes via pointer type edges. The following pseudocode summarizes an example implementation of this solution:

```
initialize sol(x) of each variable x in the graph to NTARR (bottom of the lattice)
initialize worklist W to include constant nodes PTR, ARR, NTARR
while nonempty(W) do
  let x = take(W)
  foreach ptr-type edge x −> y
      set sol(y) = sol(y) ␣ sol(x)
      if sol(y) changed, insert(y,W)
foreach constant node c && each ptr-type edge x −> c
    if c < sol(x) set fail(x) = true
foreach x such that fail(x) is true
  set checkedsol(x) = WILD and likewise all x −> ... −> y via ptr-type edges
```

To illustrate the solving of least solutions for returns, per the above, consider the following example based on the multigraph 1205 of FIG. 12A:

```
initialize/reinitialize solutions for returns, locals
  sol(foo:p, bar:q) = ARR //from greatest solutions for params in step1
  sol(foo:$ret, foo:$ret_to_bar, r, s, bar:$ret) = NTARR
initialize W = {ARR, foo:p, bar:q} //include solved nodes
enter while loop
  let x = take(W), so x is ARR //no edges from in this example
  let x = take(W), so x is foo:p
    edge foo:p−> foo:$ret
      set sol(foo:$ret) = NTARR ␣ ARR = ARR
      insert(foo:$ret,W)
  let x = take(W), so x is bar:q
    edge bar:q−> foo:p
      set sol(foo:p) = ARR ␣ ARR = ARR //unchanged
  let x = take(W), so x is foo:$ret
    edge foo:$ret−> foo:$ret_to_bar
      set sol(foo:$ret_to_bar) = NTARR ␣ ARR = ARR
      insert(foo:$ret_to_bar,W)
  let x = take(W), so x is r
    edge foo:$ret_to_bar −> r
      set sol(r) = NTARR ␣ ARR = ARR
      insert(r, W)
```

which yields solutions at this stage of:

sol(foo:p, bar:q) = ARR
sol(foo:$ret, foo$ret_to_bar, r) = ARR
sol(s, bar:$ret) = NTARR

In a third step, the constraint solver may further utilize the multigraph to compute a greatest solution for unbounded return and local variables. Unbounded returns may refer to a subset of the function returns that are not reachable (via traversal of type edges) to any of the constant type nodes or other nodes for which a solution has already been found in the multigraph, leading to the solution being unbounded and thus artificially driven to an overspecific solution. Accordingly, in the second step of determining a least solution for function returns, only the solutions for bounded returns are preserved, while unbounded returns are reinitialized and solved in this third solution step. The solution step begins by initializing the unbounded returns and local variables to the greatest solution and using solution values determined for pointers in the preceding two steps, along with any constant type nodes. The while loop is entered again for the unbounded return and local variables to iteratively determine a solution set that satisfies the lattice ordering constraints, as in the first step. For instance, in the example of FIG. 12A, this step may proceed according to:

```
initialize/reinitialize solutions for unbounded returns and local variables
  sol(foo:p, bar:q, foo:$ret, foo$ret_to_bar) = ARR //from steps 1 and 2
  sol(r, s, bar:$ret) = PTR
initialize W = {ARR, foo:p, bar:q, foo:$ret, ...} //includes solved nodes
enter while loop
  ... do the algorithm ...
```

Which in the example of FIG. 12A solves to:

sol(foo:p,bar:q) = ARR
sol(foo:$ret,foo$ret_to_bar) = ARR

In sum, per the discussion above, an example constraint solving approach may be three-phased by first computing the greatest solution for function parameters, then computing the least solution for (bounded) returns, and then computing the greatest solution for what remains (e.g., local variables, structured fields, and unbounded returns). This is carried out by first computing the greatest solution overall, but then resetting the solutions for returns, local variables, unbounded returns, etc. Then it computes the least solution, resetting the solutions for locals, etc., and finishing by solving with the greatest solution for the remaining variables/pointers, solving is linear time for each step. This approach may be configured to provide optimal flexibility and accuracy in the code. For instance, the greatest solution for parameters ensures the greatest flexibility for future callers. The higher the solution on the lattice ordering, the more callers can be admitted (e.g., an NTARR can still be passed when an ARR is expected). Similarly, generality can be gained by using the least solution on returns. While the greatest solution allows flexibility, using a greatest solution on returns potentially drops information that could be useful. For instance, while PTR may work for a particular program, it may limit future uses of the function that may like to know that it returns a more specific data (e.g., ARR data). As discussed above, using least solutions for returns is limited to bounded returns, or returns that are constrained, directly or transitively by a constant (e.g., ARR from array usage, or from interacting with an itype) or an already solved parameter qualifier, etc. Otherwise, unbounded returns are to be solved to the greatest solution (e.g., as a completely unconstrained return is typically a singleton pointer (e.g., PTR), rather than an artificially specific pointer type (e.g., NTARR). Similarly, the greatest solution for locals and structured fields provides the best generality.

In some implementations, the three-phase solving approach may be used to produce more general solutions to other sorts of qualifier constraints, which are also organized as a lattice. For example, instead of NTARR<ARR<PTR, other example lattices may be used, such as a lattice UNTAINTED<TAINTED which determines whether data so labeled is to be deemed trustworthy (UNTAINTED) or not (TAINTED). Constraints could be generated as described above, and based on usage of library functions, e.g., that functions such as getenv() would return TAINTED data, while functions such as system() would expect data to be UNTAINTED. The three-phase solving approach would improve the generality of the code to which the solution applied, among other example advantages and use cases.

When the wild/safe and pointer type solutions have been determined for each pointer in the code by a constraint solver engine, corresponding checked language syntax may be identified and either added, automatically, to the code, or output as suggestions via annotations to the code. FIG. 12C shows an example of updated, or rewritten, code 1250 as generated by an example source code converter using the solutions determined from a multigraph using an example constraint solver. For instance, safe variables/pointers for which solutions have been determined, may be replaced by corresponding checked versions of these pointer types, such as shown in FIG. 12C in the declared-type differences between 1250 and 1205. Where wild or unsafe pointers have been identified, annotations may be automatically added to the code to indicate the same, or the code may be simply left alone (the latter case is what is shown in the figure.

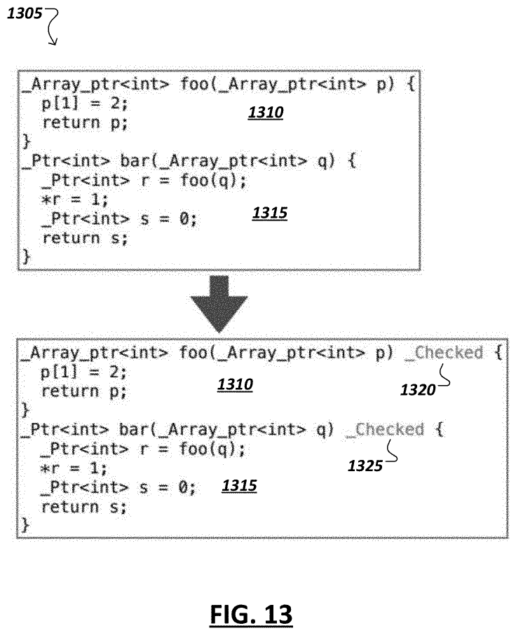

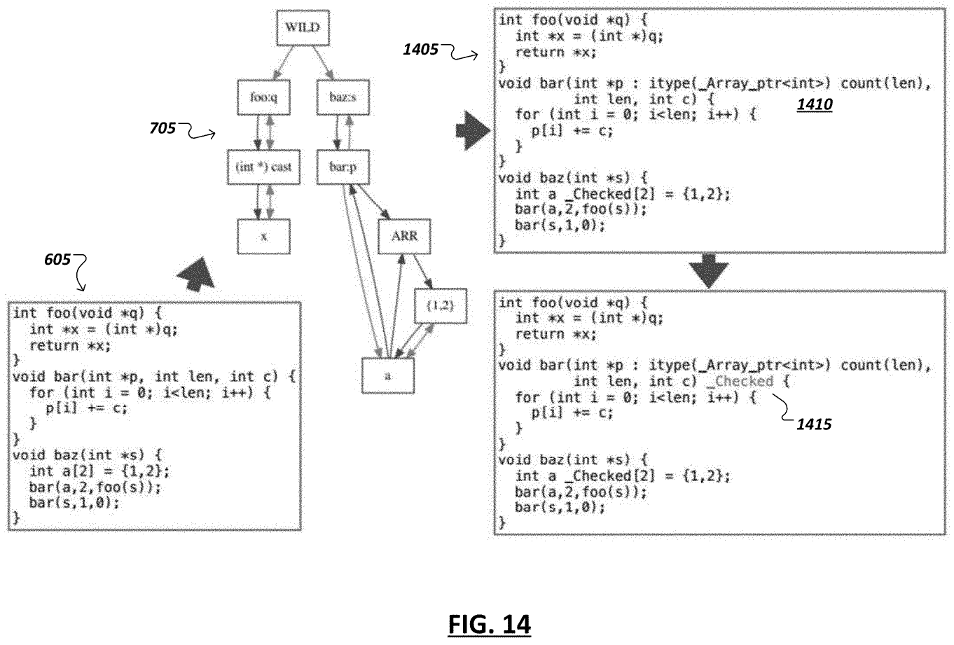

In some implementations, the constraint solving process performed by a constraint solver engine may identify regions (blocks) of code that are completely safe and free from any spatial safety violations. Such regions of code may be referred to as checked regions, characterized by the complete use of safe pointers (no wild pointers) within the region of code. In some implementations, the source code converter may additionally annotate or modify code to identify checked regions of code, determined from the solutions calculated by the constraint solver engine. For instance, FIG. 13 shows an example of code 1305 which is assessed by a source code converter to generate a multigraph (e.g., using a constraint builder), from which constraint solutions are determined. Based on these constraint solutions (e.g., using the example techniques discussed above), the source code converter may further identify that no wild pointers are included in on one or more regions (e.g., 1310, 1315) of code. Based on this determination, the source code converter may infer that these regions are safe, or checked, regions and may automatically annotate the code with corresponding annotations 1320, 1325. For instance, in Checked C, checked regions may be annotated with the _Checked keyword, among other example annotations defined in Checked C. Other “checked” programming languages may use similar or modified versions of “checked” annotations to convey similar concepts. FIG. 14 shows an example of the rewriting of a piece of code 605 (similar to the code in the examples of FIGS. 6A-11) based on constraint solving performed using multigraph 705. The safe pointers have been rewritten by the source code converter in rewritten code 1405. The source code converter may further identify that a particular region 1410 of the code 605 is free of wild pointers (as determined through constraint solving based on multigraph 705) and may further annotate the code (at 1415) with a keyword to indicate the safety of the region, among other examples.

In some implementations, the conversion of code can be carried out as a kind of qualifier inference, where each unannotated legacy C pointer (e.g., in an example of conversation to Checked C) is associated with a qualifier variable q whose solution is a pair (k, p), where k and p are qualifier constants. These constants come from two distinct lattices: k∈{chk, wild} indicates a checked vs. non-checked pointer with chk<wild. p indicates a type of checked pointer (if the pointer is not wild), or p∈{ntarr, arr,ptr}, where ntarr<arr<ptr. Qualifier constraints will apply to either the k or p portion of the solution (k,p).

These two different forms of constraints, kind (k) and p-type (p) constraints, induce two different constraint graphs. Qualifier constraints may arise from several sources. Most directly, they come from subtyping constraints, such as leveraging checked types that appear in the source program. One source of checked-type qualifiers comes from interface types, or itypes, which give a legacy function an as-if-checked type. For example, the itype of strtok's return type is ntarr, because strtok returns a NULL-terminated array pointer. Thus for the code char*s=strtok( . . . ), the return type from strtok induces constraint chk≤qₛ in the kind graph and ntarr≤qₛ in the p-type graph.

Continuing with this example if an extern function does not have an itype, then its parameters and return are deemed unchecked. Constraints may also arise from pointer usages. For instance, if a particular pointer qₛ is used as an array, it induces a constraint qₛ≤arr. Similarly, if a pointer type is cast unsafely, then a constraint wild≤qₛ is generated, similar to the principles discussed above. After generating and solving the constraints, if a particular pointer's qualifier is k=wild, the source code converter may leave this pointer alone in the output program (or rewritten code). Alternatively, if k=chk, then the source code converter may automatically rewrite it according to the determined solution for the pointer (e.g., according to a corresponding Checked C syntax).

As discussed above, a constraint builder engine may be configured to generate checked edges in addition to type edges to form a multigraph. The checked edges may be generated so as to limit or contain overinclusive wildness based on type edges in the graph. This may be utilized effectively where the presumption is that a source code converter will be used iteratively by a programmer/developer, such that root causes of wildness will be addressed by the programmer between iterations of the source code converter.

Checked edges, for instance, may prevent wildness from propagating (perhaps incorrectly) from callers to callees, as is more typical in flow models. Such overinclusive wildness may cause developers to waste time looking at functions that have unchecked parameters (and returns) but are actually safe, rather than focusing on those functions that contain (or call) unsafe code. By allowing the type on the function to signal whether it deserves attention (e.g., based on a rewriting by the source code converter based on constraint solving), these designations identify that a corresponding function is internally safe, but has unsafe callers that should be considered. Accordingly, in some implementations, an example constraint builder may implement checked edges, which reverse the parameter kind constraints on function calls. In traditional qualifier inference, for a function f with parameter p, the call y=f(x) would induce constraints qx≤qp, qr et≤qy. In the improved constraint builder discussed herein, such parameter edges are reversed: qp≤qx, qret≤qy. In this way, if f uses p in a way that causes it to be wild, this wildness will propagate back to callers. The same happens (as is typical) with the return. On the other hand, if the function uses p safely internally, then it would be acceptable for the caller's argument x to be wild (since chk<wild), given p′s itype.

Internal to a function, the source code converter may unify kind constraints; e.g., x=y induces constraints qy≤qx and qx≤qy, represented as a bidirectional edge qx↔qy. Doing so avoids casts to/from checked pointers within a function. A statement return a also induces a bidirectional edge, so that the value “flows out” of the function. Accordingly, a constraint builder engine may generate a fresh qualifier variable node at each call site to represent the returned value, such as in other examples discussed above.

If not all pointers are converted to checked after running a source code converter, such as described above, the developer may strive to manually correct as many wild pointers as possible based on the results returned by the source code converter (or other tool including a constraint builder engine and/or constraint solver engine). Specifically, the source code converter may generate an output that identifies code that is a root cause of wildness, meaning that it is responsible for a direct checked edge WILD→q in the multigraph. This is a place where, for example, an unsafe cast occurs or where an external function's parameters or return were made wild. Fixing a root cause may result in positive downstream effects, such as discussed above. Upon making manual adjustments to the code, the code may be resubmitted to the source code converter and reanalyzed. Doing so may result in additional annotated or modified code generated by the source code converter, and potentially an indication that all wildness has been effectively eradicated from the code.

An example source code converter may be equipped with additional example features and functionality. For instance, multigraphs generated by the source code converter may be generated to automatically link to corresponding source code, such that the multigraph may be co-presented or even serve as a graphical user interface element within an IDE or other software development tool. As another example, additional analysis may be performed during constraint solving, such as determining or inferring array bounds for solutions that are array-based (e.g., ARR, NTARR, etc.), among other example functionality.

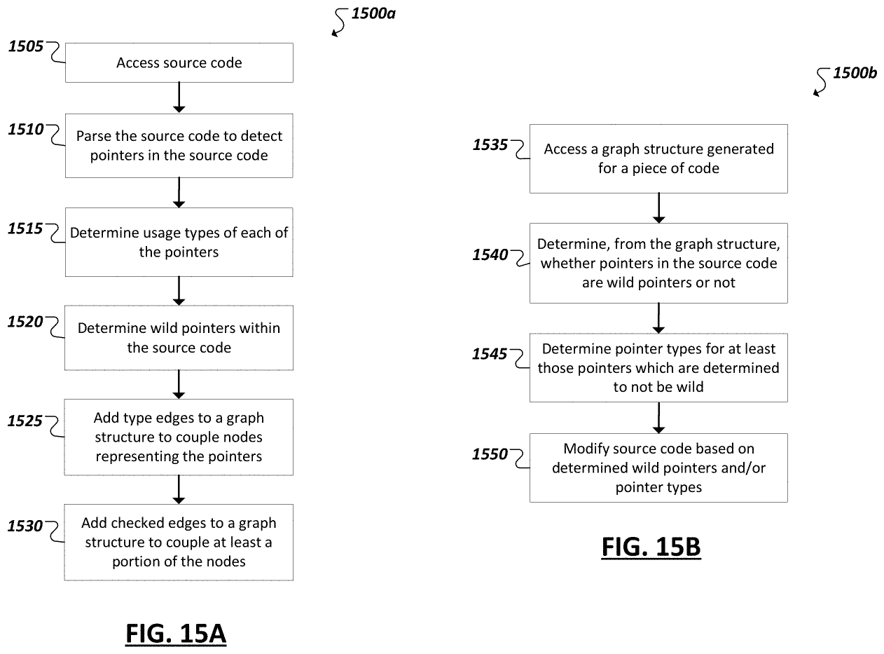

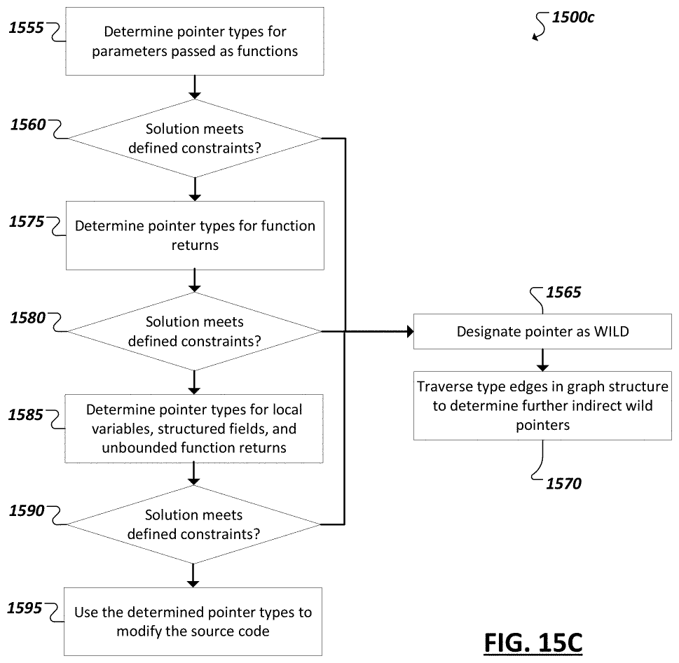

Turning to FIGS. 15A-15C simplified flowcharts 1500a-c are presented illustrating example techniques for assessing and improving source code of a software program. For instance, in the example of FIG. 15A, a piece of source code is accessed 1505 (e.g., from local memory or from a remote computing system requesting the services of an example source code converter tool) and the source code is parsed 1510 to detect a set of pointers within the source code. The usage types or patterns may be determined 1515 (e.g., arrays, pointers, function calls, function returns, etc.) for each of the pointers. The pointers may be assessed to determine 1520 whether they are characteristics of their use that make them spatially unsafe, or wild. If so, nodes in a graph structure may be generated for the pointers and checked edges may be added 1525 from a WILD type node to the nodes representing these wild pointers. Type edges may be added to connect nodes to one another (and potentially other type nodes (e.g., ARR, PTR, etc.) to reflect a flow of a program and relationships between the various nodes and their represented pointers (e.g., function calls, returns, referencing a variable in another variable, etc.). Based on the determined usage types, checked edges may also be added in an addition to and separate from the type edges within the graph to form a multigraph. The checked edges may be added in a manner, which localizes wild conditions and the propagation of wildness to limit the overinclusive attribution of indirect wildness to pointers within the graph.

Turning to the example of FIG. 15B, a multigraph developed by a tool (such as in the example of FIG. 15A) may be accessed 1535 and used to determine 1540 whether individual pointers in a piece of source code are wild or not (based on the checked edges within the multigraph). The multigraph may be further utilized to determine 1545 pointer types for at least those pointers determined to be spatially safe (or not wild). Pointer types may be determined based on the type edges in the graph structure. The source code may then be modified by changing the syntax of one or more of the pointers (for which pointer types were determined) in the source code or annotating the source code (e.g., to identify wild or safe portions of code, opportunities to modify code (e.g., to a checked language), etc. based on the determinations 1540, 1545 derived from the multigraph structure.

FIG. 15C shows an example of determining pointer types for pointers in source code using an example multigraph, such as discussed herein. The pointer type solving may take place in three phases, beginning with determining 1555 pointer types for parameter passed as functions. The solutions are to meet a set of constraints defined by the multigraph (e.g., based on relationships (e.g., represented by type edges) between pointers and a lattice ordering of pointer types. If the solution meets the defined constraints, solutions for these pointers may be saved and used in a following stage (e.g., 1575). If no solution can be found for a given parameter pointer that meets the constraints, the pointer may be designated as a wild pointer (at 1565) and the type edges in the multigraph may be traversed 1570 from this wild pointer to determine if any additional pointer inherit this wildness (and should also be designated as wild). Pointer types may then be determined 1575 for function returns. While determining 1555 pointer types for parameters may be biased toward a greatest solution, determining 1575 pointer types for function returns may be biased toward a least solution, among other example implementations. Solutions for the function return pointer types may be based on the solutions meeting constraints (at 1580) defined according to the type edges in the multigraph. Again, where a solution for a given pointer may not be found, it may be designated as wild (at 1565) and indirect wildness may be tested based on the type edges coupling the pointer to other pointers in the graph. Further, pointer types may be determined 1585 for local variables, structured fields, and unbounded function returns (e.g., biased toward to a greatest solution), and the solutions tested 1590 against the defined constraints. If no solutions are found for these pointers, the pointer may likewise be designated as wild (e.g., at 1565, 1570). From the determined pointer types, the source code may be modified, through rewriting of the determined pointers (e.g., into a checked form) or through annotation (e.g., to identify wild and/or checked code regions), among other example usages.

The flowcharts and block diagrams in the Figures illustrate the architecture, functionality, algorithms, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
accessing data comprising a graph structure, wherein the graph structure comprises a representation of source code, and the graph structure comprises:
a plurality of nodes to represent a plurality of pointers within the source code;
a plurality of type edges connecting nodes in the plurality of nodes within the graph structure, wherein the type edges identify a flow of a program to be implemented using the source code; and
a plurality of checked edges based on respective usage of pointers in the plurality of pointers;
determining, from the graph structure, whether one or more of the plurality of pointers comprise wild pointers based on one or more of the plurality of checked edges; and
determining, from the graph structure, pointer types for at least a portion of the plurality of pointers based on one or more of the plurality of type edges.

2. The method of claim 1, wherein determining whether one or more of the plurality of pointers comprise wild pointers comprises:
identifying, within the graph structure, a wild type node;
identifying a particular one of the plurality of checked edges connecting from the wild type node to a first one of the plurality of nodes representing a first one of the plurality of pointers; and
determining that the first pointer is wild based on the particular checked edge.

3. The method of claim 2, wherein determining whether one or more of the plurality of pointers comprise wild pointers further comprises:
identifying another one of the plurality of checked edges connecting from the first node to a second node in the plurality of nodes representing a second one of the plurality of pointers; and
determining that the second pointer comprises a wild pointer based on the second checked edge.

4. The method of claim 2, further comprising determining that the first pointer comprises a root cause of a wild condition within the source code based on the particular checked edge.

5. The method of claim 4, further comprising autonomously generating an annotation within the source code to identify the first pointer as a root cause of the wild condition.

6. The method of claim 2, further comprising:
attempting to traverse the graph structure using the checked edges from the wild type node to the plurality of nodes; and
determining that a subset of the plurality of pointers represented by a subset of the plurality of nodes are spatially safe based on a failure to traverse from the wild type node to the subset of nodes using the checked edges.

7. The method of claim 1, further comprising autonomously modifying the source code corresponding to the portion of the plurality of pointers based on the determined pointer types.

8. The method of claim 7, wherein the source code is modified to replace syntax of the portion of the pointers with corresponding syntax of a checked version of a programming language.

9. The method of claim 1, wherein the portion of the pointers comprise pointers determined to be spatially safe based on corresponding checked edges in the graph structure.

10. The method of claim 1, wherein determining pointer types for at least the portion of the plurality of pointers comprises:
determining pointer types for a first subset of the plurality of pointers, wherein the first subset comprises parameters to functions in the source code;
determining pointer types for a second subset of the plurality of pointers after determining pointer types for the first subset of pointers, wherein the second subset comprises returns from functions in the source code; and
determining pointer types for local variables after determining pointer types for the second subset of pointers.

11. The method of claim 10, wherein pointer types are determined based on a defined ordering of a set of pointer types, and defined ordering is based on a level of specificity offered by each respective pointer type.

12. The method of claim 11, wherein the set of pointer types comprise a pointer (PTR) pointer type, an array (ARR) pointer type, and a NUL-terminated array (NTARR) pointer type, and the defined ordering comprises NTARR<ARR<PTR.

13. The method of claim 11, wherein the pointer types are determined based on constraints defined by the type edges and the defined ordering.

14. The method of claim 11, further comprising designating a pointer as wild if no solution can be found to determine a pointer type consistent with the constraints.

15. A non-transitory machine-readable storage medium with instructions stored thereon, wherein the instructions, when executed by a machine, cause the machine to:
access data comprising a graph structure, wherein the graph structure comprises a representation of source code, and the graph structure comprises:
a plurality of nodes to represent a plurality of pointers within the source code;
a plurality of type edges connecting nodes in the plurality of nodes within the graph structure, wherein the type edges identify a flow of a program to be implemented using the source code; and
a plurality of checked edges based on respective usage of pointers in the plurality of pointers;
determine, from the graph structure, whether one or more of the plurality of pointers comprise wild pointers based on one or more of the plurality of checked edges; and
determine, from the graph structure, pointer types for at least a portion of the plurality of pointers based on one or more of the plurality of type edges.

16. The storage medium of claim 15, wherein the instructions are further executable by the machine to cause the machine to autonomously modify the source code corresponding to the portion of the plurality of pointers based on the determined pointer types.

17. The storage medium of claim 15, wherein the instructions are further executable by the machine to cause the machine to autonomously annotate the source code to identify whether at least one of the plurality of pointers are wild or safe.

18. A system comprising:
a data processing apparatus;
a memory; and
a constraint solver engine, executable by the data processing apparatus to:
access data from the memory, wherein the data comprises a graph structure, wherein the graph structure comprises a representation of source code, and the graph structure comprises:
a plurality of nodes to represent a plurality of pointers within the source code;
a plurality of type edges connecting nodes in the plurality of nodes within the graph structure, wherein the type edges identify a flow of a program to be implemented using the source code; and
a plurality of checked edges based on respective usage of pointers in the plurality of pointers;
determine, from the graph structure, whether one or more of the plurality of pointers comprise wild pointers; and
determine, from the graph structure, pointer types for at least a portion of the plurality of pointers.

19. The system of claim 18, further comprising a compiler, wherein the compiler comprises the constraint solver engine.

20. The system of claim 18, further comprising a constraint builder engine executable by the data processing apparatus to generate, from the source code, the graph structure.

21. The system of claim 18, further comprising a code annotator executable by the data processing apparatus to modify the source code based on the determined pointer types.
